(19) United States
(12) Patent Application Publication
(10) Pub. No.: US 2010/0000723 A1
(43) Pub. Date: Jan. 7, 2010

(54) System, Method and Apparatus for Transferring Heat

(76) Inventor: Colin James Chambers, New South wales (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/280,481

(22) PCT Filed: Feb. 16, 2007
(86) PCT No.: PCT/AU2007/000173

§ 371 Date: Dec. 18, 2008

(30) Foreign Application Priority Data
Feb. 23, 2006 (AU) 2006900907

(51) Int. Cl. F28D 1/04; C02F 1/02

(52) U.S. Cl. 165/163; 165/164

(57) ABSTRACT

A system, method and apparatus for transferring heat are disclosed. They make use of the first receptacle having an inlet for ingress of the first liquid, such as sewage, and an outlet for egress of the first liquid. Also provided is a second receptacle having an inlet for ingress of the second liquid, such as exhausted heated water from an air conditioning or cooling unit, and an outlet for egress of the second liquid. The second receptacle comprises a portion located in a proximity of the first receptacle. The first and second receptacles are arranged such that they allow a quantity of heat to transfer from the second liquid to the first liquid. The apparatus may be configured for inline connection to a sewerage main.

### FIELD OF THE INVENTION

The present invention relates generally to the field of transferring heat, and more particularly—but by no means exclusively—to the field of transferring heat from water used for cooling an air conditioning unit (or a generator) to another liquid.

### BACKGROUND OF THE INVENTION

Air conditioning units based in medium to large water-cooled chillers and direction expansion condensing units as well as evaporative cycle technology typically compress a gas (such as a Freon) so as to effect a state change of the gas to liquid. This high pressure liquid is then passed through a flow restriction orifice (expansion valve) across which is created a pressure differential. Liquid traversing this point is converted back to gas due to the reduction in pressure, created by the suction side of the compressor. This process is endothermic, the heat input being the latent heat required to effect the state change back to gaseous. The fluid to be cooled provides this heat and the transfer to this evaporative stage of the refrigeration is effected by passing it through a heat exchanger such as a coiled tube with fins effectively increasing the surface contact area for the transfer. A fan is typically employed to increase the rate at which the fluid contacts these dissipation/transfer fins.

Although this basic means of heat transfer is effective, it is possible to employ alternative techniques which have specific advantages and/or disadvantages compared to the abovementioned system. Such techniques include the transfer of heat to or from a liquid, rather than to or from the atmosphere directly. One such example is a conventional water-based cooling tower. In this device, heat from a fluid is transferred from its closed system by passing it through a heat exchanger the external surface of which is in contact with cool water. The heat exchanger transfers heat to this water, effecting its evaporation. Unfortunately, cooling towers are usually very large unsightly objects that have relatively high capital and running costs, result in the loss of water from evaporation and require biocidal maintenance to reduce or eliminate algal growth and Legionella bacteria.

### SUMMARY OF THE INVENTION

According to one aspect of the present invention, there is provided a system for transferring heat, the system comprising:

a first receptacle having an inlet for ingress of a first liquid and an outlet for egress of the first liquid; and

a second receptacle having an inlet for ingress of a second liquid and an outlet for egress of the second liquid, the second receptacle comprising a portion located in a proximity of the first receptacle, the first and second receptacles being arranged such that they allow a quantity of heat to transfer from the second liquid to the first liquid.

Advantageously, one or more embodiments of the system may enable a waste liquid (the first liquid), such as sewage, to be used as a heat-sink. This may be desirable in areas where fresh water (which is typically used by existing cooling towers) is scarce. More specifically, as the second liquid (which is typically heated) flows through the conduit heat from the second liquid may pass to the waste liquid contained in the receptacle, to thereby cool the second liquid. Another advantage of one or more embodiments of the system is that transferring heat to waste liquid may assist in breaking down the waste liquid, which may be particularly advantageous when the waste liquid is sewage.

Preferably, the second liquid comprises heated water that has been used to cool an air conditioning unit.

Optionally, the second receptacle is externally closely adjacent to an external surface of the first receptacle. The second receptacle may form a jacket on or about at least a portion of the first receptacle. The first receptacle may comprise a portion of a sewerage conduit. The second receptacle may comprise an element and the proximity of the first receptacle comprises a portion of the element being located in the first receptacle.

Preferably, the system comprises a metering means for recording a quantity of the first liquid that enters the inlet.

An advantage of incorporating the metering means into an embodiment is that it enables the supplier (owner) of the first liquid to record the amount of the first liquid entering the receptacle, which can assist the supplier with regard to billing a third party for the amount of the first liquid.

Preferably, the receptacle comprises a vent for allowing a gas from the first liquid to flow from the receptacle.

The vent may assist in preventing a potentially dangerous build-up of the gas in the receptacle, which could occur in the case where the first liquid includes, for example, sewage. In which case, the gas could include methane.

Preferably, the system comprises a gas storage means for collecting and storing the gas for use in the generators being mixed in with the natural gas fuel.

Incorporating the gas storage means into the system may provide the advantage of being able to store the gas for subsequent use.

Alternatively, it is envisaged that the system comprises a gas dispersing system for dispersing the gas into the atmosphere. Further alternatively, where the receptacle is configured as a conduit for flow of liquid therethrough without storage, dispersal or collection of gas from the first liquid may not be required.

Optionally, the first receptacle is configured to store the first liquid for a predetermined time period.

Preferably, the first liquid comprises sewage.

An advantage of using sewage as the first liquid in the system is that there is generally a ready supply of sewage. Moreover, the use of sewage as a heat-sink may not be subject to the same strict environmental constraints as some other liquids such as, for example, sea water drawn from a harbour or fresh water used in existing cooling towers.

Alternatively, it is envisaged that other liquids could be used in place of sewage. For example, the first liquid could comprise grey water, storm water or creek/river water.

An advantage of using heated water from the air conditioning unit is that the embodiment of the system according to the first aspect of the present invention can potentially replace traditional cooling towers, which can be unsightly and relatively expensive.

Preferably, the first and second receptacles are located underground.

An advantage of locating the receptacles underground is that the receptacles are out of sight and would not have a visual impact.

According to another aspect, there is provided a method for transferring heat, the method comprising the steps of:

providing a quantity of a first liquid in a first receptacle that has: an inlet for allowing the first liquid to flow into the receptacle; and an outlet for allowing the first liquid to flow out of the receptacle; and

effecting a flow of a second liquid through a second receptacle that has a portion that is located in a proximity of the first receptacle, the first and second receptacles being arranged such that they allow a quantity of heat to transfer from the second liquid to the first liquid.

Optionally, the first liquid comprises a waste liquid. The waste liquid may comprise sewage. The second liquid may comprise heated water that has been used to cool an air conditioning unit and engines of generators.

Optionally, the second receptacle may be externally closely adjacent to an external surface of the first receptacle. The second receptacle may form a jacket about at least a portion of the first receptacle. The first receptacle may comprise a portion of a sewerage conduit.

The second receptacle may comprise an element and the proximity of the first receptacle comprises a portion of the element being located in the first receptacle.

Preferably, the method comprises the step of recording, using a metering means, a quantity of the first liquid that enters the inlet.

Preferably, the method comprises the step of allowing a gas from the first liquid to flow from the receptacle via a vent therein.

Preferably, the method comprises the step of collecting and storing the gas in a gas storage means.

Preferably, the second liquid comprises heated water that has been used to cool an air conditioning unit.

Preferably, the gas comprises methane.

Preferably, the receptacle is located underground.

According to another aspect of the present invention, there is provided a system for transferring heat, the system comprising:

a receptacle for storing a quantity of a first liquid, the receptacle having: an inlet for allowing the first liquid to flow into the receptacle; and an outlet for allowing the first liquid to flow out of the receptacle; and

an element that has a portion that is located in a proximity of the receptacle and which defines a conduit for a flow of a second liquid, the element and the receptacle being such that they allow a quantity of heat to transfer from the second liquid to the first liquid to thereby provide a system for transferring heat.

According to another aspect of the present invention, there is provided a method for transferring heat, the method comprising the steps of:

storing a quantity of a first liquid in a receptacle that has: an inlet for allowing the first liquid to flow into the receptacle; and an outlet for allowing the first liquid to flow out of the receptacle; and

effecting a flow of a second liquid through an element that has a portion that is located in a proximity of the receptacle and which defines a conduit for the flow, the element and receptacle being such that they allow a quantity of heat to transfer from the second liquid to the first liquid to thereby provide a system for transferring heat.

Alternatively, the proximity of the receptacle comprises the portion of the element being located on an outer surface of the receptacle.

According to another aspect there is provided a heat transfer apparatus comprising:

a conduit having an inlet and an outlet for passage of a first liquid therethrough; and

a receptacle having an inlet and an outlet for passage of a second liquid therethrough, the first and second receptacles being arranged in proximity to each other such that they allow a quantity of heat to transfer from the second liquid to the first liquid.

Optionally, the conduit may be arranged for inline fluid communicative connection to a waste liquid conduit, wherein the first liquid comprises waste liquid.

The waste liquid conduit may be a sewerage conduit and the waste liquid may comprise sewage.

Advantageously, the apparatus may be configured such that it is relatively simple to replace an existing section of sewage line or sewage mains with the apparatus.

Optionally, the conduit may comprise a first connection flange at the conduit inlet and a second connection flange at the conduit outlet wherein the flanges are configured for connection to complementary respective flanges on a waste liquid conduit.

The apparatus may comprise a jacket on or about at least a portion of the conduit. The receptacle may comprise a second conduit disposed at least in part at an external surface of the first mentioned conduit. A length of the second conduit may be longer than the length of the first conduit. The second conduit may be located about at least a portion of the first conduit. Further, the second conduit may be helically formed about at least a portion of the first conduit.

Optionally, the receptacle may be configured to receive exhausted cooling water from an air conditioning unit.

The process of heat transfer from the second liquid to the first liquid may result in at least partial treatment of the first liquid. The at least partial treatment may comprise breaking down of a heat sensitive microbial component of the first liquid. Optionally, the system or apparatus may comprise, or the method may make use of, a treatment device for treatment of the first liquid. Optionally, the system or apparatus may comprise or the method may make use of a device for removing at least part of the treated first liquid from the first receptacle. Advantageously, the removed treated first liquid may then be used, depending on its level of treatment, for grey water applications, etc.

In the specification and claims, the terms “receptacle” is to be understood in its broadest sense, being something capable of receiving. In its broadest sense, a receptacle may comprise a temporary storage device, such as a tank; or a fluid flow device, such as a pipe or conduit.

### BRIEF DESCRIPTION OF THE DRAWINGS

Notwithstanding any other embodiments that may fall within the scope of the present invention, embodiments will now be described, by way of example only, with reference to the accompanying figures, in which:

FIG. 1 provides a schematic diagram of a system according to an embodiment of the present invention; and

FIGS. 2 and 3 provide perspective views of apparatus in accordance with alternative embodiments of the present invention.

### DETAILED DESCRIPTION OF PREFERRED EMBODIMENTS

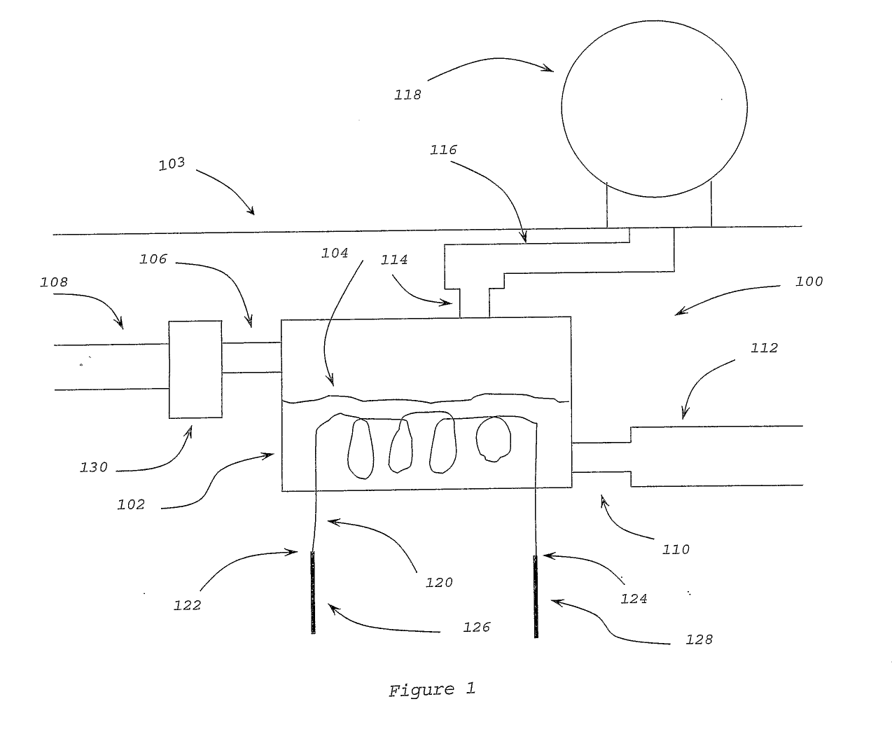

With reference to FIG. 1, a system 100 according to an embodiment of the present invention comprises a receptacle in the form of tank 102 located below a ground surface 103, the tank 102 being capable of holding approximately 30,000 litres of a first liquid in the form of sewage 104. The tank 102 is made from concrete or other non-erodible material. However, it is envisaged that in alternative embodiments of the present invention the tank 102 can be made of other material such a plastic.

The tank 102 comprises an inlet 106 for allowing the sewage 104 to flow into the tank 102. In this regard, the inlet 106 is coupled to a pipe 108 carrying the sewage 104 from one or more sources, which may for instance be one or more domestic residences. In addition to the inlet 106, the tank 102 also comprises an outlet 110 for allowing the sewage 104 in the tank 102 to flow out of the tank 102. The outlet 110 is coupled to another pipe 112 that carries the sewage 104 to a processing facility, which is typically a sewage processing plant.

In this embodiment, the tank 102 also comprises a vent 114 from which a gas, typically methane, given off from the sewage 104 in the tank 102 can escape from the tank 102. Without the vent 114 the gas is likely to build up to dangerous levels in the tank 102. The vent 114 is coupled to a pipe 116, which carries the gas from the vent 114 to a gas storage facility 118. The advantage of transporting the gas to the storage facility 118 is that the gas (which as mentioned previously may comprise methane) can be used for other purposes such as fuel in cogeneration based energy systems. Alternatively, it is envisaged that in another embodiment of the present invention the gas from the vent 114 maybe dispersed into the atmosphere instead of being captured and stored in the storage facility 118. In the embodiment in which the gas is dispersed into the atmosphere the pipe 116 coupled to the vent 114 is also coupled to a venting stack, which disperses the gas into the atmosphere.

The system 100 also comprises a second receptacle, or element in the form of a copper tube 120. The tube 120 can be made from another material, such as steel, in an alternative embodiment of the present invention. The tube 120 is by and large located in the tank 102 and is in a coiled configuration such that the tube 120 is substantially submerged in the sewage 104 contained in the tank 102. Persons skilled in the art will, however, appreciate that the present invention is not limited to having the tube 120 located in the tank 102. For instance, in an alternative embodiment of the invention the tube 120 or part thereof can be attached to an outside surface of the tank 102. The tube 120 has an inlet 122 and an outlet 124 for allowing a second liquid to flow through the tube 120. In use, the inlet 122 is coupled to a pipe 126 that carries the second liquid, which in this embodiment is in the form of exhausted heated water from an air conditioning or cooling unit.

As persons skilled in the art will readily appreciate, the exhausted water from the air conditioning unit has been used to cool the air conditioning unit. As the exhausted water flows through the tube 120, a quantity of heat contained in the exhausted water will pass therefrom into the sewage 104 contained in the tank 102 via the wall of the tube 120. Consequently, the exhausted water flowing from the outlet 124 of the tube 120 is cooler than the exhausted water flowing into the inlet 122 of the tube 120. In this regard, the outlet 124 is coupled to another pipe 128 that carries the cooled exhausted water back to the air conditioning unit for cooling purposes.

In one example where the first liquid is sewage and the second liquid is air conditioning exhausted cooling water, an approximate temperature range of sewage in the receptacle 102 is 15-20° C., an approximate temperature of the exhausted water entering the element 120 at inlet 122 is 90° C. and an approximate temperature of cooled exhausted water exiting the element 120 via outlet 124 is approximately 70° C. As will be understood, the system 100 therefore provides a possibility of a temperature drop of approximately 20° C. of exhausted cooling water passing through the system 100, and the cooling liquid can then be recirculated back to the air conditioning system for re-use in removing heat therefrom. As will be understood, in different conditions, being operational, environmental, or other, the temperature of the sewage, exhausted cooling water and the cooled exhausted water may vary from these examples.

It is worth noting the system illustrated in FIG. 1 is arranged to operate in a batch like process, where the receptacle 102 temporarily stores a minimum volume of the sewage therein. This is particularly useful where there is intermittent flow of sewage through the system and thus ensures the tube 120 is in contact with a minimum required amount of sewage; that is where the tube 120 is submerged within the sewage at all times during the use. However, as will be understood, in practice there is a typically minimum flow of sewage through a sewage mains and as such the tank 102 and tube 120 can be sized such that the tube 120 is continually immersed in sewage in the tank 102.

It is noted that an alternative embodiment of the present invention includes a stirring mechanism located on the tank 102 for mixing up the liquid in the tank 102 to ensure no sediment builds up over time. In this regard, it is envisaged that the stirring mechanism is operated periodically by an AC power source.

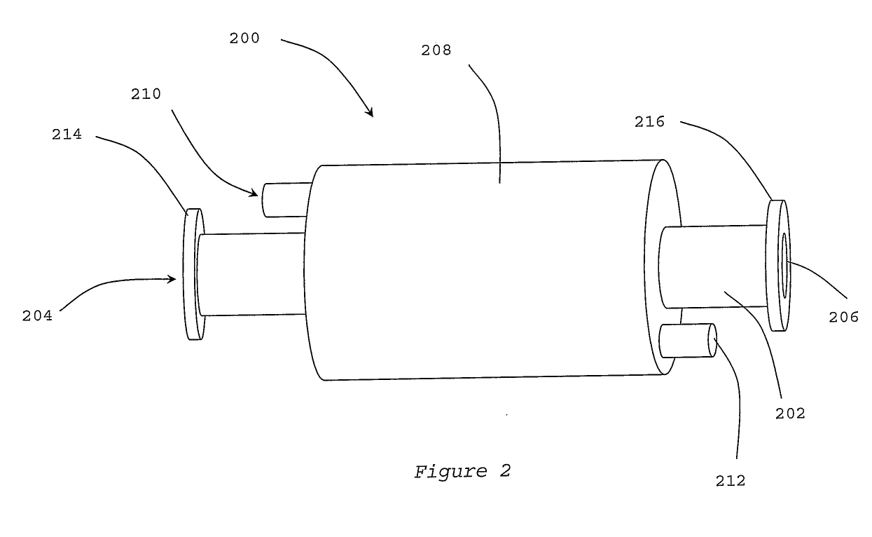

FIG. 2 illustrates an alternative embodiment. In this embodiment, the system comprises an apparatus 200 which has a conduit 202 comprising an inlet 204 and an outlet 206 for the passage of a first liquid in the form of sewage therethrough. A receptacle in the form of a jacket 208 comprises an inlet 210 and an outlet 212 for the passage of a second liquid in the form of exhausted air conditioning cooling water therethrough. The jacket 208 is arranged in close proximity to the conduit 202 to allow heat transfer between sewage in the conduit 202 and exhausted water in the jacket 208.

The conduit further comprises a pair of flanges 214, 216 at its inlet 204 and outlet 206, respectively. The flanges are present to enable inline connection of the apparatus 200 to corresponding flanges on a sewerage main, however other appropriate connection means may be employed as appropriate. The apparatus 200 has been configured such that a length of sewerage main conduit can be replaced with the apparatus 200 such that the conduit 202 is in inline fluid communication with the sewerage main.

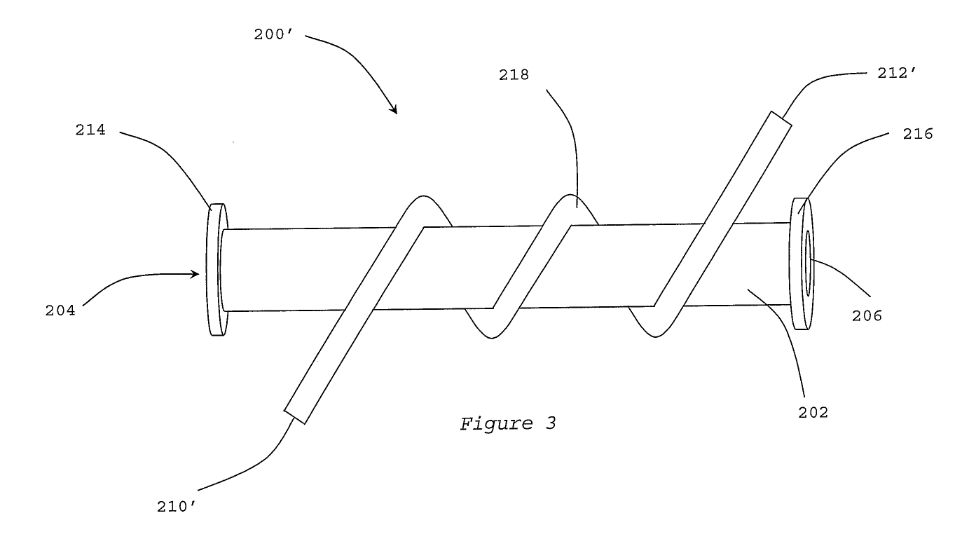

FIG. 3 illustrates an alternative arrangement of the apparatus 200′ illustrated in FIG. 2 where like reference numerals denote like parts. In this embodiment, the receptacle is in the form of a helical conduit 218 which is formed about a portion of the first mentioned conduit 202. The helical conduit 218 comprises an inlet 210′ and an outlet 212′ for connection to an exhausted air conditioning cooling water supply to form a circuit therewith. The inlet 204 and outlet 206 of the sewage conduit 202 is connected inline with a sewage main in a similar manner as described above with respect to the embodiment illustrated in FIG. 2. Heat transfer is therefore permitted between the relatively hotter exhausted cooling water flowing through the helical conduit 218 and the sewage flowing through the sewage conduit 202 such that the temperature of the cooling water leaving the outlet 212′ is a relatively lower temperature than when it enters the helical conduit 218 via inlet 210′. It is preferred that the helical conduit 218 and/or the conduit 202 are manufactured from copper, however any suitable material may be used such as another metal or a plastic. In another alternative embodiment, the embodiments illustrated in FIGS. 2 and 3 could be combined, that is to say the helical conduit 218 could be formed within the jacket 208 such that the jacket protects the helical conduit 218 in situ.

A further optional component of the system 100 is a meter 130. The meter 130 is coupled to the pipe 108 carrying the sewage to the inlet 106 of the tank 102. The meter 130 is coupled to the pipe 108 such that it is capable of measuring and recording the amount of the sewage 104 flowing into the first inlet 106. Being able to measure and record the amount of the sewage 104 is advantageous because it allows an entity (such as a sewage authority) to charge for the amount of sewage 104 entering the tank 102. As will be understood, the meter 130 could also be employed for the same purposes in the embodiments illustrated in FIGS. 2 and 3.

The above embodiments have been described with particular reference to the use of sewage as a heat sink in the heat transfer process. It can be beneficial using sewage as a heat sink as a sewerage system would typically be situated nearby a source of the second liquid such as exhausted cooling water from air conditioning or air cooling systems. However, it will be understood that similar opportunistic use of nearby waste or other water sources may be made in this application, such as use of storm water or creek water as the heat sink. Similarly, the second liquid need not be exhausted air conditioning cooling water, but may include exhausted cooling liquid or water used to cool power generators, and the like.

In an alternative arrangement, the system 100 may be configured such that the sewage passing therethrough is at least in part treated to a grey water re-use standard. This may be achieved by the heat transfer to the first liquid aiding in breaking down of heat sensitive microbial components of the sewage in combination with an additional treatment device in the form of a filter for removing solids from the sewage, and optionally a chemical treatment device, such as a chlorine treatment device, each being employed in a known configuration. This would allow for re-use of the treated sewage in at least grey water applications, such as watering of plants and fields, etc.

While the present invention has been described with reference to the aforementioned embodiments, it will be understood by those skilled in the art that alterations, changes and improvements maybe made and equivalents maybe substituted for the elements thereof and steps thereof without departing from the scope of the present invention. In addition, many modifications maybe made to adapt to a particular situation or material to the teachings of the present invention without departing from the central scope thereof. Such alterations, changes, modifications and improvements, although not expressly described above, are nonetheless intended and implied to be within the scope and sprit of the invention. Therefore, it is intended that the invention not be limited to the particular embodiments described as the best mode contemplated for carrying out the present invention, but that the invention will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A system for transferring heat, the system comprising:
a first receptacle in fluid communication with a sewage main and being arranged for continuous flow of sewage therethrough; and
a second receptacle having an inlet for ingress of a cooling liquid and an outlet for egress of the cooling liquid, the second receptacle comprising a portion located in a proximity of the first receptacle, the first and second receptacles being arranged such that they allow a quantity of heat to transfer from the cooling liquid to the sewage.

2. A system for transferring heat, the system comprising:
a first receptacle arranged for fluid communication with a sewerage main having an inlet for ingress of a sewage and an outlet for egress of the sewage and being arranged for continuous flow of the sewage therethrough; and
a second receptacle having an inlet for ingress of a cooling liquid and an outlet for egress of the cooling liquid, the second receptacle comprising a portion located in a proximity of the first receptacle, the first and second receptacles being arranged such that they allow a quantity of heat to transfer from the cooling liquid to the sewage.

3. The system of claim 2 wherein the first receptacle is adapted for inline fluid communication with the sewerage main.

4. The system of claim 2, wherein the cooling liquid comprises heated water that has been used to cool one or more of a cooling unit, an air conditioning unit and a power generator.

5. The system of claim 2, wherein the second receptacle is externally closely adjacent to an external surface of the first receptacle.

6. The system of claim 5, wherein the second receptacle forms a jacket on or about at least a portion of the first receptacle.

7. The system of claim 6, wherein the first receptacle comprises a portion of a sewerage conduit.

8. The system of claim 2, wherein the second receptacle comprises an element and the proximity of the first receptacle comprises a portion of the element being located in the first receptacle.

9. The system of claim 2, comprising a metering means for recording a quantity of the sewage that enters the inlet.

10. The system of claim 2, wherein the first receptacle comprises a vent for allowing a gas from the sewage to flow from the first receptacle.

11. The system of claim 10, comprising a gas storage means for collecting and storing the gas.

12. The system of claim 10, wherein the gas comprises methane.

13. The system of claim 2, wherein the first and second receptacles are located underground.

14. The system of claim 2 comprising a treatment device for treatment of the sewage.

15. The system of claim 14, comprising a device for removing at least a portion of the treated sewage from the first receptacle.

16. A method for transferring heat, the method comprising the steps of:
providing a flow of a sewage through a first receptacle that has:
an inlet adapted for fluid communication with a sewerage main for allowing the sewage to flow into the first receptacle; and
an outlet for allowing the sewage to flow out of the first receptacle; and
effecting a flow of a cooling liquid through a second receptacle that has a portion that is located in a proximity of the first receptacle, the first and second receptacles being arranged such that they allow a quantity of heat to transfer from the cooling liquid to the sewage.

17. A method of claim 16 wherein the step of providing flow of the sewage includes the step of providing a continuous flow of the sewage.

18. The method of claim 16, wherein the cooling liquid comprises heated water that has been used to cool one or more of a cooling unit, an air conditioning unit and a power generator.

19. The method of claim 16, wherein the second receptacle is externally closely adjacent to an external surface of the first receptacle.

20. The method of claim 19, wherein the second receptacle forms a jacket about at least a portion of the first receptacle.

21. The method of claim 16, wherein the first receptacle comprises a portion of a sewerage conduit.

22. The method of claim 16, wherein the second receptacle comprises an element and the proximity of the first receptacle comprises a portion of the element being located in the first receptacle.

23. The method of claim 16, comprising the step of recording, using a metering means a quantity of the sewage that enters the inlet.

24. The method of claim 16, comprising the step of allowing a gas from the sewage to flow from the first receptacle via a vent therein.

25. The method of claim 24, comprising the step of collecting and storing the gas in a gas storage means.

26. The method of claim 24, wherein the gas comprises methane.

27. The method of claim 16, wherein the first and second receptacles are located underground.

28. The method of claim 16, comprising the step of treating the sewage.

29. The method of claim 28, comprising removing at least a portion of the treated sewage from the first receptacle.

30. A heat transfer apparatus comprising:
a conduit adapted for fluid communication with a sewerage main and having an inlet and an outlet for passage of a sewage therethrough; and
a receptacle having an inlet and an outlet for passage of a cooling liquid therethrough, the conduit and receptacle being arranged in proximity to each other such that they allow a quantity of heat to transfer from the cooling liquid to the sewage.

31. The apparatus of claim 30, wherein the conduit is arranged for inline fluid communicative connection to the sewerage main.

32. The apparatus of claim 31, wherein the conduit is a sewerage conduit.

33. The apparatus of claim 32, wherein the conduit comprises a first connection flange at the conduit inlet and a second connection flange at the conduit outlet such that the apparatus is arranged to replace a section of sewerage main.

34. The apparatus of claim 30, wherein the receptacle comprises a jacket about at least a portion of the conduit.

35. The apparatus of claim 30, wherein the receptacle comprises a second conduit disposed at least in part at an external surface of the first mentioned conduit.

36. The apparatus of claim 35, wherein a length of the second conduit is longer than the length of the first conduit.

37. The apparatus of claim 36, wherein the second conduit is located about at least a portion of the first conduit.

38. The apparatus of claim 35, wherein the second conduit is helically formed about at least a portion of the first conduit.

39. The apparatus of claim 30, wherein the receptacle is configured to receive cooling water from one or more of a cooling unit, an air conditioning unit and a power generator.

40-42. (canceled)
